(19) United States
(12) Patent Application Publication
(10) Pub. No.: US 2026/0242053 A1
(43) Pub. Date: Aug. 20, 2026

(54) PROPELLER BLADE AND METHOD FOR REPAIRING A PROPELLER BLADE

(71) Applicant: RÖDER PRÄZISION GMBH, Egelsbach (DE)

(72) Inventor: Jörg ERDMANN, Vaterstetten (DE)

(73) Assignee: RÖDER PRÄZISION GMBH, Egelsbach (DE)

(21) Appl. No.: 19/542,483

(22) Filed: Feb. 17, 2026

(30) Foreign Application Priority Data
Feb. 19, 2025 (DE) 102025106139.4

(51) Int. Cl. B64C 11/06; B64C 11/26

(52) U.S. Cl. CPC B64C 11/06; B64C 11/26

(57) ABSTRACT

The invention relates to a propeller blade for an aircraft propeller, comprising a wing section and a propeller blade root connected thereto, as well as a method for repairing such a propeller blade. The wing section may have a foam and/or honeycomb core with a sheath made of a fiber-reinforced polymer material. The propeller blade root may be made of a metallic material and may have a shaft extending into and connected to the wing section, at least one outer bearing ring, and an adjustment pin. It is preferred that the bearing ring has a running surface consisting of a layer of a steel material welded or remelted onto the bearing ring, which has a yield strength Rₚ0.2of over 750 N/mm^{²} and a tensile strength Rm of over 1,000 N/mm^{²}. The bearing ring with the running surface can have a core Vickers hardness HV10 of over 430.

The invention relates to a propeller blade for an aircraft propeller comprising a wing section and a propeller blade root connected thereto, and a method for repairing such a propeller blade.

Propeller blades are frequently manufactured from fiber-reinforced composite materials with metal inserts, the wing section often having a foam core or a honeycomb core with a covering made of a fiber-reinforced polymer material. The propeller blade root, which is usually made of a metallic material, serves to connect the propeller blade to the hub of a propeller. The propeller blade root often has a shaft extending into and connected to the blade section, and at least one bearing ring by which the propeller blade root is mounted in the hub. Propeller blades are usually rotatably mounted in the hub so that their angle of attack can be changed. To this end, the propeller blade root often has an adjustment pin that interacts with an adjustment drive. Such propeller blades are known from EP 0 610 273 B1 or FR 2 877 917 B1.

During operation, the bearing ring is subjected to sometimes high mechanical loads, so that it can wear, especially on its running surface. EP 3 431 388 B1 therefore proposes a propeller blade retaining element in which a running ring section made of a second, different corrosion-resistant and induction-hardenable steel, for example X40CrMoV16-2 stainless steel, is friction-welded onto a body section made of a first corrosion-resistant steel, for example, stainless steel X12CrNiMoV12. This running ring section is to be hardened either before or after it has been welded to the body section. This method is suitable for the manufacture of a new propeller blade by attaching a blade section to the propeller blade retaining element.

Furthermore, EP 3 257 743 B1 proposes, in the case of a propeller blade with a fiber- reinforced structure, applying a running ring made of a tungsten-cobalt-carbide alloy with a hardness greater than 45 Rc as a spray to the blade retaining section. This method can also be used for repair purposes.

There is a further need for a propeller blade with an improved propeller blade root and the ability to repair a propeller blade. The object of the invention is therefore to propose a propeller blade with a particularly resistant bearing ring and a method for repairing a propeller blade.

This object is achieved with a propeller blade according to claim 1 and a method according to claim 6.

A propeller blade according to the invention comprises a wing section made of a fiber composite material and a propeller blade root connected thereto. The wing section can thus have a foam and/or honeycomb core with a sheathing made of a fiber-reinforced polymer material, and the propeller blade root can be made of a metallic material and have a shaft extending into and connected to the wing section, at least one outer bearing ring, and an adjustment pin. Advantageously, the bearing ring is provided with a running surface made of a layer of a particularly resistant steel material welded or melted onto the bearing ring and, if necessary, hardened. This steel can have a yield strength R_{p0.2} of over 750 N/mm^{²}, for example, between 750 N/mm^{²} and 900 N/mm^{²}, particularly around 760 N/mm^{²}. Alternatively or additionally, the steel material can have a tensile strength Rₘ of over 1,000 N/mm², for example between 1,100 N/mm² and 1,500 N/mm², in particular about 1,350 N/mm² to 1,400 N/mm². These material properties can be achieved with some weldable, stainless steels used in the aerospace industry, which are also suitable for subsequent hardening. In this way, a propeller blade with a wear-resistant running surface can be manufactured or repaired.

For the suitability of the layer as a running surface for a ball or roller bearing, it has proven advantageous if its core has a Vickers hardness HV10 of over 400, for example, between 420 and 450, preferably around 430. The core Vickers hardness can be determined according to DIN EN ISO 6507-1:2024-1 with a test force of 98.07 N (corresponding to HV 10).

In addition to the core hardness, the achievable surface hardness is also an important property for the running surface. For example, the running surface can have a surface hardening depth (SHD 550 HV 1) of over 1.5 mm, for example, from 1.6 mm to 2.5 mm, and in particular from about 1.8 mm to 2.0 mm. The surface hardening depth (SHD) can be determined according to DIN EN ISO 18203:2022-07 with a test force of 9.807 N.

In a preferred example, the running surface can have a Vickers hardness (HV10) of over 700 at a distance of 0 mm to 0.5 mm from the surface, for example, between about 710 and 800.

In principle, the running surface layer and the rest of the propeller blade root do not have to be made of identical materials, as long as they are sufficiently weldable. However, it can be advantageous if the running surface layer and the rest of the propeller blade root are made of the same material. A suitable stainless steel for aerospace applications can contain, for example, the following elements in addition to iron (Fe): carbon (C) between 0.08 and 0.15 wt%, manganese (Mn) between 0.4 and 0.9 wt%, silicon (Si) up to 0.5 wt%, phosphorus (P) up to 0.03 wt%, sulfur (S) up to 0.025 wt%, chromium (Cr) between 11.0 and 12.5 wt%, nickel (Ni) between 2.0 and 3.0 wt%, molybdenum (Mo) between 1.5 and 2.0 wt%, vanadium (V) between 0.25 and 0.4 wt%, and nitrogen (N) between 0.02 and 0.04 wt%. For example, this is the stainless steel X12CrNiMoV12.

An inventive method for repairing a propeller blade can comprise the following steps: providing a propeller blade with a wing section and with a metallic propeller blade base with a bearing ring, applying a layer of stainless steel to the bearing ring or remelting a layer of the bearing ring, machining the layer to form a running surface geometry on the bearing ring, optionally hardening the running surface so that it has a Vickers hardness HV10 of over 430 and a surface hardening depth SHD 550 HV 1 of over 1.5 mm. Machining can be performed before and/or after hardening.

The special feature of the inventive method is that the layer forming the running surface is welded on while the metallic propeller blade root is connected to the blade section, which has a foam and/or honeycomb core with a sheath made of a fiber-reinforced polymer material. Therefore, it is not necessary to separate the blade section, which is usually bonded and sometimes also mechanically connected to the propeller blade root. This could lead to damage to the blade section and is therefore avoided. On the other hand, repairing a propeller root connected to the wing section using thermal methods has been avoided so far, because this too could damage the wing section itself or its connection to the propeller blade root. It has been found that applying a layer of stainless steel, in particular a steel such as X12CrNiMoV12-3 with a yield strength _{Rp0}.₂ of over 750 N/mm^{²} and a tensile strength Rₘ of over 900 N/mm^{²}, to the bearing ring does not damage a wing section made of a fiber composite material.

The stainless steel layer can be applied using electron beam welding or laser beam welding with a wire feeder, for example, to replace material lost due to wear on the running surface. In this process, at least the bearing race of the propeller blade root can be subjected to a vacuum in a vacuum chamber, allowing impurities to be removed from the weld pool. It may be necessary to protect the blade section from negative pressure to prevent gases trapped in the foam or honeycomb core from damaging the fiber composite structure. For propeller blade repair, it may also be sufficient to simply remelt the bearing race's running surface without adding any material. This is particularly useful if only very small amounts of the running surface material have been lost due to wear.

The hardening of the running surface can be achieved, for example, by induction hardening, which reduces the amount of heat transferred to the blade section and its connection to the propeller blade root. If the running surface and the bearing ring already possess sufficient hardness after weld overlay or remelting, particularly in the areas specified above as preferred for the propeller blade, the hardening step can be omitted.

Furthermore, it can be advantageous to implement heat dissipation measures during weld overlay and induction hardening to protect the fiber composite material and its connection to the propeller blade root from excessively high temperatures. This can involve shielding the blade section from thermal radiation and/or cooling the propeller blade root.

The invention is explained in more detail below with reference to the drawing. This document schematically shows:

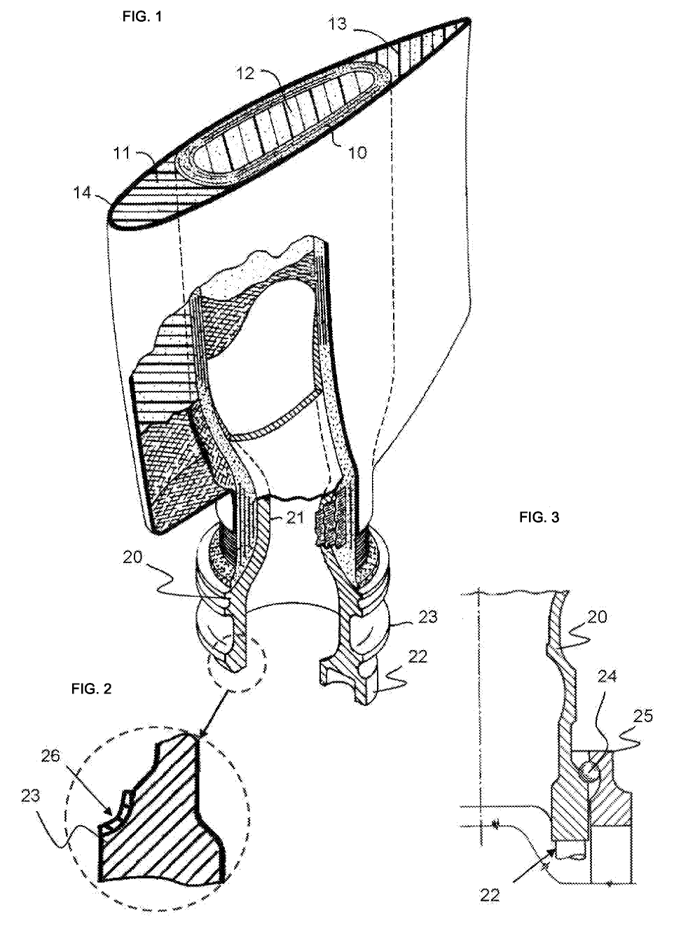

FIG. 1, a partially cutaway view of a propeller blade according to the invention,

FIG. 2, a detail from FIG. 1; and

FIG. 3, a bearing arrangement of a propeller blade according to the invention.

FIG. 1 shows an exemplary propeller blade of a known basic structure, consisting essentially of a wing section 10 and a propeller blade root 20 connected to it.

In the illustrated example, the wing section 10 has a core made of several foam elements 11, 12, 13, which are provided with a sheath 14 made of a fiber-reinforced polymer material. The invention is not limited to the exemplary construction of the wing section 10 with several core elements shown.

For connection to the hub of a propeller, the propeller blade is provided with the metallic propeller blade root 20. The propeller blade root 20 has a shaft 21 extending into the wing section 10, which is firmly connected to the wing section 10, for example by means of adhesive bonding. In FIGS. 1 and 3, an adjusting pin 22 is indicated on the propeller blade root 20, which can interact with an adjusting drive (not shown) to change the angle of attack of the propeller blade. For this purpose, the propeller blade root 20 is rotatably mounted in the hub by means of a bearing arrangement indicated in FIG. 3. This bearing arrangement essentially comprises an outer bearing ring 23 of the propeller blade root 20, several balls 24, optionally guided in a cage (not shown), and a bearing ring 25 of the hub.

At the connection point formed by the bearing arrangement between the propeller hub (stroke) and the propeller blade root 20, the running surface of the bearing ring 23 on the propeller blade root 20 wears down with frequent propeller adjustment. The wear can be a combination of abrasive wear and plastic deformation. Propeller blades are taken out of service when wear limits are exceeded and must be replaced or repaired.

According to the invention, the latter can be achieved by a repair process in which missing material on the running surface of the bearing ring 23 is replaced by build-up welding, for example with electron beam and wire (so-called EB welding), thereby applying a layer 26 to the bearing ring 23. According to the invention, a layer consisting of stainless steel X12CrNiMoV12 can be applied while the blade section 10 remains connected to the propeller blade root 20. The propeller blade can be exposed to a vacuum during build-up welding, with protective measures optionally being taken to protect the fiber composite part of the propeller blade, i.e., the blade section 10, from the vacuum.

Induction hardening of the machined areas on the propeller blade root 20 achieves a core Vickers hardness HV10 of over 430, a surface hardening depth SHD 550 HV1 of over 1.5 mm, and a Vickers hardness HV10 of over 700 at a distance of 0.5 mm from the surface of the running surface in the bearing ring 23 and the welded layer 26.

Restoring the original geometry of the propeller blade root can be achieved by machining, e.g., turning, before and/or after hardening.

Furthermore, measures for heat dissipation during the welding and induction hardening processes can be implemented to protect the fiber composite part of the propeller blade, i.e., the blade section 10, and the connection to the propeller blade root 20 from excessively high temperatures.

### Reference Numerals:

10 Wing section

11 Foam element

12 Foam element

13 Foam element

14 Fiber-reinforced polymer casing

20 Propeller blade root

21 Shaft

22 Adjustment pin

23 Bearing ring

24 Ball

25 Bearing ring

26 of the hub. Welded layer

5

1. A propeller blade comprising a wing section and a propeller blade root connected thereto, wherein the wing section has a foam and/or honeycomb core with a sheath made of a fiber-reinforced polymer material, and wherein the propeller blade root is made of a metallic material and comprises a shaft extending into and connected with the wing section, at least one outer bearing ring, and an adjustment pin, characterized in that the bearing ring has a running surface consisting of a layer of a steel material welded or remelted onto the bearing ring, which has a yi_{eld} strength Rp0.² of over 750 N/mm² and a tensile strength Rm of over 1,000 N/mm², and that the bearing ring has a core Vickers hardness HV10 with the running surface. of over 430.

2. Propeller blade according to claim 1, characterized in that the running surface has a surface hardening depth SHD 550 HV 1 of over 1.5 mm.

3. A propeller blade according to claim 1, characterized in that the running surface has a Vickers hardness HV10 of over 700 at a distance of 0.5 mm from the surface.

4. A propeller blade according to claim 1, characterized in that the running surface consists of a steel material having a tensile strength Rₘ of over 1,300 N/mm^{²} and a Vickers hardness HV10 of over 435.

5. A propeller blade according to claim 1, characterized in that the running surface consists of a hardened layer of stainless steel X12CrNiMoV12 welded onto the bearing ring.

6. Method for repairing a propeller blade comprising the following steps:
a. providing a propeller blade with a wing section and a propeller blade base, wherein the wing section has a foam and/or honeycomb core with a sheath made of a fiber-reinforced polymer material, and wherein the propeller blade base is made of a metallic material and has a shaft extending into and connected with the wing section, at least one outer bearing ring and an adjustment pin.
b. Overlay welding of a layer of stainless steel having a yield strength R_{p0.2} of over 750 N/mm^{²} and a tensile strength Rₘ of over 900 N/mm^{²} onto the bearing ring, or remelting of a layer of the bearing ring,
c. machining of the layer to form a running surface geometry on the bearing ring,
d. optionally hardening of the running surface so that it has a Vickers hardness HV10 of over 430 and a surface hardening depth SHD 550 HV 1 of over 1.5 mm.

7. Method according to claim 6, characterized in that step b. is carried out by electron beam welding or laser beam welding.

8. Method according to claim 7, characterized in that in step b. at least the running ring of the propeller blade root is exposed to a vacuum.

9. A method according to claim 6, characterized in that step d. is carried out by means of induction hardening.

10. A method according to claim 6, characterized in that in step b. and/or in step d. the wing section is protected from thermal radiation and/or the propeller blade root is cooled.
